(19) United States
(12) Patent Application Publication
(10) Pub. No.: US 2014/0052965 A1
(43) Pub. Date: Feb. 20, 2014

(54) DYNAMIC CPU GPU LOAD BALANCING USING POWER

(71) Applicant: Uzi Sarel, Zichron-Yaakov (IL)

(72) Inventor: Uzi Sarel, Zichron-Yaakov (IL)

(21) Appl. No.: 13/995,485

(22) PCT Filed: Feb. 8, 2012
(86) PCT No.: PCT/US12/24341

§ 371 Date: Jun. 18, 2013

(51) Int. Cl. G06F 9/30

(52) U.S. Cl. CPC G06F 9/30003
USPC 712/214

(57) ABSTRACT

Dynamic CPU GPU load balancing is described based on power. In one example, an instruction is received and power values are received for a central processing core (CPU) and a graphics processing core (GPU). The CPU or the GPU is selected based on the received power values and the instruction is sent to the selected core for processing.

### BACKGROUND

General purpose graphics processing units (GPGPU) have been developed to allow a graphics processing unit (GPU) to perform some of the tasks that have traditionally been performed by central processing units (CPU). The multiple parallel processing threads of a typical GPU are well suited to some processing tasks but not others. Recently operating systems have been developed to allow some tasks to be assigned to the GPU. In addition, frameworks such as OpenCL (Open Computing Language) are being developed that allow instructions to be executed using different types of processing resources.

At the same time, some tasks that are typically performed by GPUs may be performed by CPUs and there are hardware and software systems available that are able to assign some graphics tasks to the CPU. Integrated heterogeneous systems which include a CPU and a GPU in the same package or even on the same die make the distribution of tasks more efficient. However, it is difficult to find an optimal balance for the sharing and balancing of tasks between different types of processing resources.

A variety of different proxies may be used to estimate the load on a GPU and a CPU. Software instruction or data queues may be used to determine which core is busier and then assign tasks to the other core. Similarly, the outputs may be compared to determine progress on a current workload. Counters in a command or execution stream may also be monitored. These metrics provide a direct measure of the progress or results of a core with its workload. However, the collection of such metrics requires resources and does not indicate a core's potential abilities, only how it is doing with what it has been given.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is diagram of a system for performing dynamic load balancing for running a software application according to an embodiment of the invention.

FIG. 2 is diagram of a system for performing dynamic load balancing for running a game according to an embodiment of the invention.

FIG. 3A is a process flow diagram of performing dynamic load balancing according to an embodiment of the invention.

FIG. 3B is a process flow diagram of performing dynamic load balancing according to another embodiment of the invention.

FIG. 4 is a process flow diagram of determining a power budget for performing dynamic load balancing according to an embodiment of the invention.

FIG. 5 is a block diagram of a computing system suitable for implementing embodiments of the invention.

FIG. 6 illustrates an embodiment of a small form factor device in which the system of FIG. 5 may be embodied.

### DETAILED DESCRIPTION

Embodiments of the invention may be applied to any of a variety of different CPU and GPU combinations including those that are programmable and those that support a dynamic balance of processing tasks. The techniques may be applied to a single die that includes both a

CPU and a GPU or CPU and GPU cores as well as to packages that include separate dies for CPU and GPU functions. It may also be applied to discrete graphics in a separate die, or a separate package or even a separate circuit board such as a peripheral adapter card. Embodiments of the invention allow the load of processing tasks to be balanced dynamically between CPU and GPU processing resources based on CPU and GPU power meters. The invention may be particularly useful when applied to a system where the CPU and GPU share the same power budget. In such a system, it may be possible to take power consumption and power trends into account.

Dynamic load balancing may be particularly useful for 3D (three-dimensional) processing. A compute and power headroom for the CPU allows the CPU to assist with 3D processing and, in this way, more of the system's total computational resources are used. CPU/GPU APIs (Application Programming Interfaces) such as OpenCL may also benefit from dynamically load-balancing kernels between the CPU and GPU. There are many other applications for dynamic load balancing that provide higher performance by allowing another processing resource to do more. Balancing the work between the CPU and the GPU allows a platform's compute and power resources to be more efficiently and fully utilized.

In some systems the power control unit (PCU) also provides a power meter function. Values from the power meter may be queried and collected. This is used to allow power to be distributed based on the workload demand for each separable powered unit. In the present disclosure, the power meter value is used to adjust the workload demand.

The power-meters may be used as a proxy for power consumption. Power consumption may also be used as a proxy for load. High power consumption suggests that the core is busy. Low power consumption suggests that a core is not as busy. However, there are significant exceptions for low power. One such exception is that a GPU can be “busy” since the samplers are all fully utilized, but still the GPU is not fully utilizing the power budget.

The power-meters and other indications from the power-managing hardware, such as a PCU may be used to help assess how busy the CPU and GPU are in terms of power. An assessment of the either the central processing or graphics core also allows the respective headroom for the other core to be determined. This data can be used to drive an efficient workload balancing engine that uses more of the processing platform's resources.

Commonly used performance metrics, such as busy and idle states do not provide any indication of the power headroom of a core. Using power metrics, a load-balancing engine can allow the core that is more efficient for a particular task to run at full frequency, and the core that is less efficient to run with the remaining power. As tasks or processes change the other core may be run at full power instead.

Currently some Intel® processors use a Turbo Boost™ mode in which a processor is allowed to run at a much higher clock speed for a short period of time. This causes the processor to consume more power and produce more heat, but if the processor returns to a lower speed, lower power mode quickly enough then it will be protected from overheating. Using power meters or other power indications helps to determine the CPU power headroom without reducing the use of the Turbo Boost mode. In the case of a GPU in Turbo Boost mode, the GPU may be allowed to work at its maximum frequency when desired and still the CPU can consume the remaining power.

In systems where the CPU and the GPU share the same power budget, power indications, such as power meter readings may be used to determine whether tasks can be offloaded to the CPU or to the GPU. For graphics processing, the GPU may be allowed to use most of the power and then the CPU may be allowed to help when possible, i.e. when there is enough power headroom. The GPU is generally more efficient with graphics processing tasks. On the other hand, the CPU is generally more efficient with most other tasks and general tasks, such as traversing a tree. In such a case, the CPU may be allowed to use most of the power and then the GPU may be allowed to help when possible.

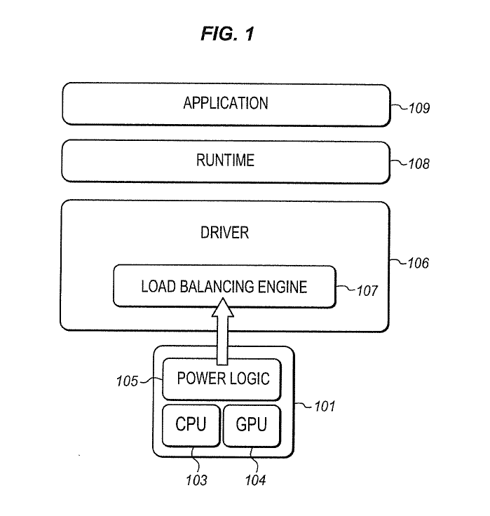

An example architecture for general purpose processing is shown in FIG. 1. A computer system package 101 contains a CPU 103, a GPU 104, and power logic 105. These may all be on the same or different dies. Alternatively, they may be in different packages and separately attached to a motherboard directly or through sockets. The computer system supports a runtime 108, such as an operating system, or kernel, etc. An application 109 with parallel data or graphics runs on top of the runtime and generates calls or executables to the runtime. The runtime delivers these calls or executables to a driver 106 for the computing system. The driver presents these as commands or instructions to the computing system 101. To control how the operations are handled, the driver 106 includes a load balancing engine 107 which distributes loads between the CPU and the GPU as described above.

A single CPU and GPU is described in order not to obscure the invention, however, there may be multiple instances of each which may be in separate packages or in one package. A computing environment may have the simple structure shown in FIG. 1, or a common workstation may have two CPUs each with 4 or 6 cores and 2 or 3 discrete GPUs each with their own power control units. The techniques described herein may be applied to any such system.

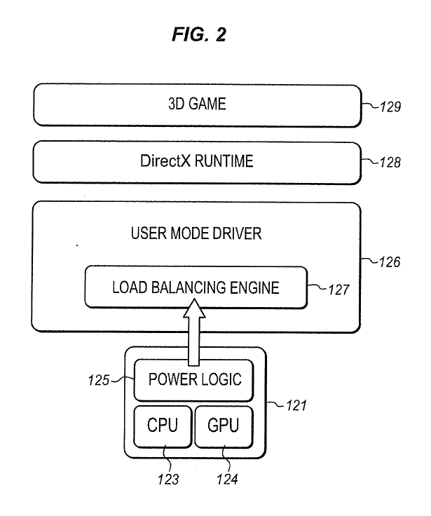

FIG. 2 shows an example computing system 121 in the context of running a 3D game 129. The 3D game 129 operates over a DirectX or similar runtime 128 and issues graphics calls which are sent through a user mode driver 126 to the computing system 121. The computing system may be essentially the same as that of FIG. 1 and include a CPU 123, a GPU 124, and power logic 125.

In the example of FIG. 1, the computing system is running an application that will be primarily processed by the CPU. However, to the extent that the application includes parallel data operations and graphics elements, these may be handled by the GPU. The load balancing engine may be used to send appropriate instructions or commands to the load balancing engine in order to shift some work load from the CPU to the GPU. Conversely, in the example of FIG. 2, the 3D game will be primarily be processed by the GPU. The load balancing engine may, however, shift some of the workload from the GPU to the CPU.

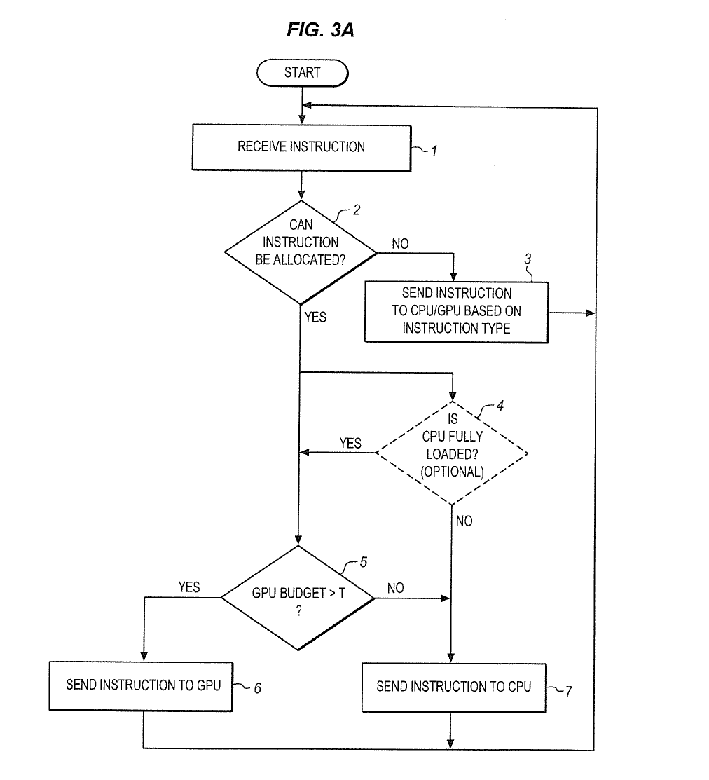

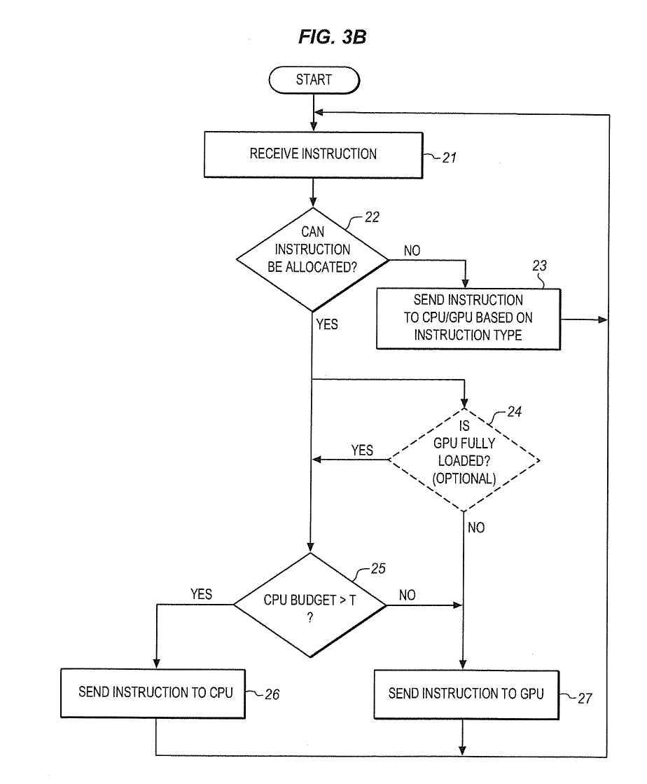

The load balancing techniques described herein may be better understood by considering the process flow diagram of FIG. 3A. At 1, the system receives an instruction. This is typically received by the driver and then available to the load balancing engine. In the example of FIG. 3A, the load balancing engine is biased in favor of the CPU as may be the case for the computer configuration of FIG. 1. The instruction may be received as a command, an API, or in any of a variety of other forms depending on the application and the runtime. The driver or the load balancing engine may parse the command into simpler or more basic instructions that may be independently processed by the CPU and the GPU.

At 2, the system examines the instruction to determine whether the instruction can be allocated. The parsed instructions or the instructions as they are received may then be sorted into three categories. Some instructions must be processed by the CPU. An operation to save a file to mass storage, or to send and receive e-mail are examples of operations for which almost all the instructions must typically be performed by a CPU. Other instructions must be processed by the GPU. Instructions to rasterize or transform pixels for display must typically be performed at the GPU. A third class of instructions may be processed by either the CPU or the GPU, such as physics calculations or shading and geometry instructions. For the third group of instructions, the load balancing engine may decide where to send the instruction for processing.

If an instruction cannot be allocated, then at 3, it is sent to either the CPU or the GPU, depending on how the instruction was sorted at 2.

If the instruction can be allocated then, the load balancing engine makes the decision where to allocate the instruction, either to the CPU or to the GPU. The load-balancing engine may use various metrics to make a smart decision. The metrics may include GPU utilization, CPU utilization, power-schemes and more.

In some embodiments of the invention, the load-balancing engine may determine whether one of the cores is fully utilized. Decision block 4 is an optional branch that may be used, depending on the particular embodiment. At 4, the engine considers whether the CPU is fully loaded. If it is not, then the instruction is passed to the CPU at 7. This biases the allocation of instructions in favor of the CPU and bypasses the decision block at 5.

If the CPU is fully loaded, then the power budgets are compared at 5 to determine whether the instruction may be passed to the GPU. Without this optional branch 4, the instruction is directly passed for a decision at 5 if it is an instruction that can be allocated. Alternatively, as shown in FIG. 3B, the engine may consider whether the GPU is fully loaded and, if so, then pass the instruction to the CPU if there is room in the CPU power budget. In either case, the operation at 4 may be removed.

The condition of the processor core as fully loaded or fully utilized may be determined in any of a variety of different ways. In one example, an instruction or software queue may be monitored. If it is full or busy, then the core may be considered to be fully loaded. For a more accurate determination the condition of a software queue holding commands can be monitored over a time interval and an amount of busy time can be compared to an amount of empty time during the interval to determine a relative amount of utilization. A percentage of busy time may be determined for the time interval. This or another amount of utilization can then be compared to a threshold to make the decision at 4.

The condition of the processor core may also be determined by examining hardware counters. A CPU and a GPU core have several different counters that may be monitored. If these are busy or active then the core is busy. As with queue monitoring, the amount of activity can be measured over a time interval. Multiple counters may be monitored and the results combined by addition, averaging, or some other approach. As examples, counters for execution units, such as processing cores or shader cores, textures samplers, arithmetic units, and other types of execution units within a processor may be monitored.

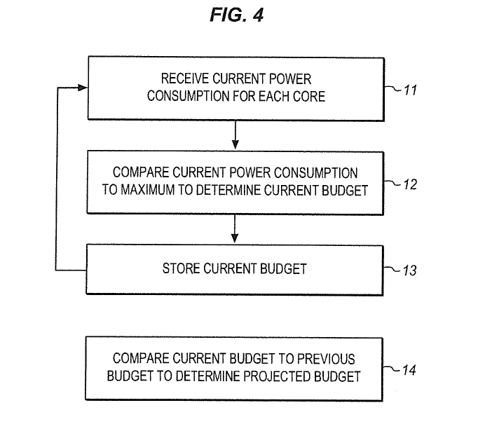

In some embodiments of the invention, power-meters may be used as part of the load-balancing engine decision. The load-balancing engine may use the current power readings from the CPU and GPU, as well as historic power data that is collected in the background. Using the current and historic data, as shown in FIG. 4 for example, the load-balancing engine calculates the power budget available for offloading work to the GPU or to the CPU. For example if the CPU is at 8W (with a TDP (Total Die Power) of 15W), and the GPU is at 9W (with a TDP of 11W), then both dies are operating below maximum power. The CPU in this case has a power budget of 7W and the GPU has a power budget of 2W. Based on these budgets, tasks may be offloaded by the load-balancing engine from the GPU to the CPU and vice versa.

For better decisions, the power meter readings of the GPU and the CPU may be integrated, averaged, or combined in some other way over a period of time, for example, the last 10 ms. The resulting integrated value can be compared to some “safe” threshold that may be configured at the factory or set over time. If the CPU has been running safely, then GPU tasks may be offloaded to the CPU. The power meter values or integrated values can be compared to a power budget. If the current work estimate can fit into the budget then it can be offloaded to the GPU. For other power budget scenarios, the work may be offloaded instead to the CPU.

At 5, the load-balancing engine compares the GPU budget to a threshold, T, to determine where to send the instruction. If the GPU budget is greater than T, or, in other words, if there is room in the GPU budget, then at 6 the instruction is sent to the GPU. On the other hand, if the GPU budget is less than T meaning that there is insufficient room in the GPU budget, then the instruction is sent to the CPU at 7. The threshold T represents a minimum amount of power budget that will allow the instruction to be successfully processed by the CPU. The threshold may be determined offline, by running a set of workloads to tune the best T. It can also be changed dynamically based on learning the active workload of the cores over time.

The decision at 5 can be biased to support a particular type of software running on the system. For a game, the load balancing engine may be configured to favor the GPU by setting the GPU budget threshold, T, lower. This may provide better performance because the GPU is able to handle the heavy graphics demands more smoothly. This may be also done using the operation at 4 or in another way.

Using another optional decision block similar to the one at 4, the GPU may also be tested to determine if it is fully loaded or if it has additional power headroom available. This may be used to allow all instructions to be sent to the GPU that can be sent to the GPU. Conversely, the CPU is selected if the GPU does not have additional power headroom. Alternatively, the load balancing engine may be configured to favor the CPU, perhaps because the GPU is weak compared to the CPU and game play is improved if the GPU is assisted. In such a case, the load balancing engine would behave in the opposite way. The CPU would be selected if the CPU has additional power headroom available. Conversely, the GPU would be selected only if the CPU does not have additional power headroom. This maximizes the instructions sent to the CPU in the gaming environment in which most of the instructions must be handled by the GPU.

This kind of bias may be built into the system based on the hardware configuration or based on the type of applications that are being run or on the types of calls that are seen by the load balancing engine. The bias may also be lessened by applying scaling or factors to the decision.

The budget referred to in this process flow is a power budget based on power meter values from the power control unit. In one example, the budget is the number of Watts that can be consumed for the next time interval without breaking the thermal limits of the CPU system. So, for example, if there is a budget of 1W that can be spent for the next time interval (e.g. 1 ms) then that would be enough budget to offload an instruction from the GPU to the CPU. One consideration in determining the budget is the impact on a GPU turbo mode such as Turbo Boost. Budgets can be determined and used with a view to maintaining a GPU turbo mode.

The budget may be obtained from the power control unit (PCU). The configuration and location of the power control unit will depend on the architecture of the computing system. In the illustrated examples of FIGS. 1 and 2, the power control unit is part of an uncore in an integrated homogeneous die with multiple processing cores and an uncore. However, the power control unit may be a separate die that collects power information from a variety of different locations on a system board. In the example of FIGS. 1 and 2, the driver 106, 126 has hooks into the PCU to collect information about power consumption, overhead, and budget.

A variety of different approaches may be used to determine a power budget. In one example, power values are received periodically from the PCU and then stored to be used each time an instruction that can be allocated is received. An improved decision process can be performed at the cost of more complex computations by tracking a history of power values over time using the periodic power values. The history can be extrapolated to provide a future power prediction value for each core. A core, either the CPU or the GPU is then selected based on the predicted future power values.

The budget value may be a comparison of a power consumption value, whether instantaneous, current, or predicted, and can be determined by comparing the power consumption value to a maximum possible power consumption for the core. If, for example, a core is consuming 12W and has a maximum power consumption of 19W, then it has a remaining budget or overhead of 7W. The budget may also take into consideration other cores as well. The total available power may be less than the total maximum power that all of the cores can consume. If, for example the CPU has a maximum power of 19W and the GPU has a maximum power of 22W, but the PCU can supply no more than 27W, then both cores cannot simultaneously operate at maximum power. Such a configuration may be desired to allow a core to operate briefly at higher rates. The load balancing engine cannot supply instructions at a rate that causes both cores to reach their respective maximum power levels. The available power budget may accordingly be reduced to account for the capability of the PCU.

FIG. 3B is a process flow diagram for a process that favors the GPU as may be used in the context of FIG. 2. At 21, the system, for example the driver 126, receives an instruction. This is made available to the load balancing engine which is biased in favor of the GPU. The driver or the load balancing engine analyzes or parses the command, depending on the implementation, to reduce it to instructions that may be independently processed by the CPU and the GPU.

At 22, the system examines the instruction to determine whether the instruction can be allocated. Instructions that must be processed by the CPU or the GPU are sent to their respective destination at 23.

If the instruction can be allocated then, the load balancing engine makes the decision where to allocate the instruction, either to the CPU or to the GPU. As in FIG. 3A, an optional operation may be used to determine whether the GPU is fully loaded at decision block 4. If it is not, then the instruction is passed to the GPU at 27 the decision block at 25 is bypassed. If the GPU is fully loaded, then the power budgets are analyzed at 25 to determine whether the instruction may be passed to the CPU.

At 25, the load-balancing engine compares the CPU budget to a threshold, T, to determine where to send the instruction. If the CPU budget is greater than T, then at 26 the instruction is sent to the CPU. On the other hand, if the CPU budget is less than T then the instruction is sent to the GPU at 27. The threshold T represents a minimum amount of power budget for the CPU and may be determined in a similar way to the threshold of FIG. 3A.

FIG. 4 shows a parallel process flow for determining a budget to be used in the process flow of FIG. 3A or 3B. In FIG. 4, at 11 the current power consumption for each core or group of cores is received. In a computing system with multiple CPU cores and multiple GPU cores, instructions may be allocated to each core individually or may be divided between central and graphics processing. A separate process for the CPU cores may then be used to distribute instructions between cores and threads if any. Similarly, this or a separate process or both may be used to distribute instructions among central processing cores or among graphics processing cores.

At 12 the received current power consumption is compared to the maximum power consumption to determine the current budget for each core. At 13, this value is stored. The current power consumption values are received periodically and so the operations at 11, 12, and 13 may be repeated. A FIFO (First In First Out) buffer may be used so that only some number of budget values is stored. The most recent value may be used in the operations of FIG. 3 or some operation may be performed on the values as at 14.

At 14, the current and previous budget values are compared to determine a projected budget. The projected budget is then used as the budget values for the operations of FIG. 3. The comparison may be performed in a variety of different ways depending on the particular implementation. In one example an average may be taken. In another example, an extrapolation or integration may be performed. The extrapolation may be limited to maximum and minimum values based on other known aspects of the power control system. More complex analytical and statistical approaches may alternatively be used depending on the particular implementation.

In an alternative approach, to those described in FIGS. 3A and 3B, the current processing core power load may simply be compared to the total available. TDP=normal operation power envelope. As mentioned above the TDP (Total Die Power) will be determined by the PCU or by the thermal design constraints of the die. The budget may be determined simply by subtracting the current power load of the CPU and GPU cores from the TDP. The budget may then be compared to a threshold amount of budget. If the budget is more than the threshold, then the instruction can be allocated to the other core.

As a further operation, the other core can also be checked to determine whether it is operating within its allocated power range before the instruction is offloaded. This simplified approach may be applied to a variety of different systems and may be used to offload instructions to either a CPU or a GPU or to particular cores.

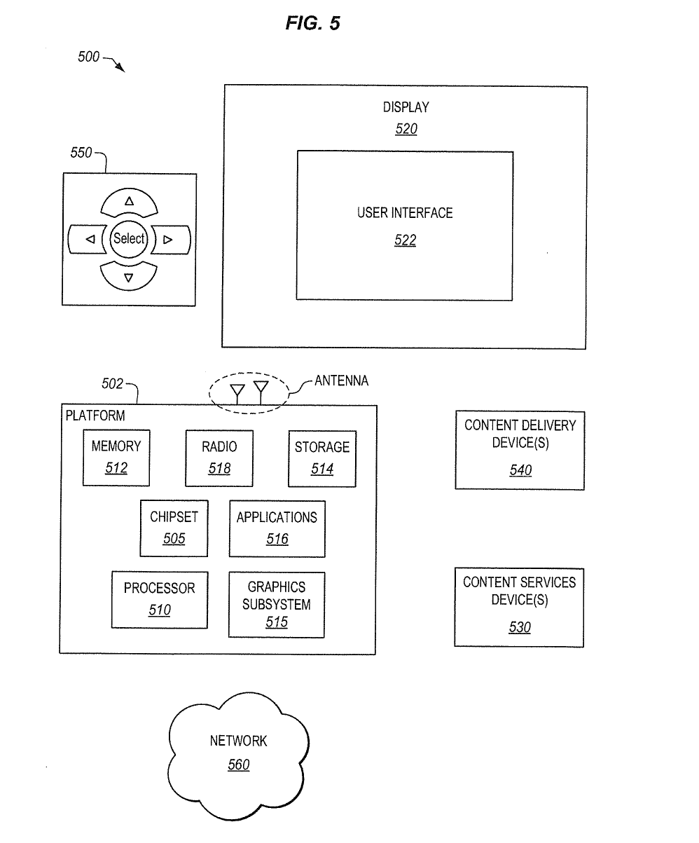

FIG. 5 illustrates an embodiment of a system 500. In embodiments, system 500 may be a media system although system 500 is not limited to this context. For example, system 500 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 500 comprises a platform 502 coupled to a display 520. Platform 502 may receive content from a content device such as content services device(s) 530 or content delivery device(s) 540 or other similar content sources. A navigation controller 550 comprising one or more navigation features may be used to interact with, for example, platform 502 and/or display 520. Each of these components is described in more detail below.

In embodiments, platform 502 may comprise any combination of a chipset 505, processor 510, memory 512, storage 514, graphics subsystem 515, applications 516 and/or radio 518. Chipset 505 may provide intercommunication among processor 510, memory 512, storage 514, graphics subsystem 515, applications 516, and/or radio 518. For example, chipset 505 may include a storage adapter (not depicted) capable of providing intercommunication with storage 514.

Processor 510 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor 510 may comprise dual-core processor(s), dual-core mobile processor(s), and so forth.

Memory 512 may be implemented as a volatile memory device such as, but not limited to, a Random Access Memory (RAM), Dynamic Random Access Memory (DRAM), or Static RAM (SRAM).

Storage 514 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 514 may comprise technology to increase the storage performance enhanced protection for valuable digital media when multiple hard drives are included, for example.

Graphics subsystem 515 may perform processing of images such as still or video for display. Graphics subsystem 515 may be a graphics processing unit (GPU) or a visual processing unit (VPU), for example. An analog or digital interface may be used to communicatively couple graphics subsystem 515 and display 520. For example, the interface may be any of a High-Definition Multimedia Interface, DisplayPort, wireless HDMI, and/or wireless HD compliant techniques. Graphics subsystem 515 could be integrated into processor 510 or chipset 505. Graphics subsystem 515 could be a stand-alone card communicatively coupled to chipset 505.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Radio 518 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area networks (WMANs), cellular networks, and satellite networks. In communicating across such networks, radio 518 may operate in accordance with one or more applicable standards in any version.

In embodiments, display 520 may comprise any television type monitor or display. Display 520 may comprise, for example, a computer display screen, touch screen display, video monitor, television-like device, and/or a television. Display 520 may be digital and/or analog. In embodiments, display 520 may be a holographic display. Also, display 520 may be a transparent surface that may receive a visual projection. Such projections may convey various forms of information, images, and/or objects. For example, such projections may be a visual overlay for a mobile augmented reality (MAR) application. Under the control of one or more software applications 516, platform 502 may display user interface 522 on display 520.

In embodiments, content services device(s) 530 may be hosted by any national, international and/or independent service and thus accessible to platform 502 via the Internet, for example. Content services device(s) 530 may be coupled to platform 502 and/or to display 520. Platform 502 and/or content services device(s) 530 may be coupled to a network 560 to communicate (e.g., send and/or receive) media information to and from network 560. Content delivery device(s) 540 also may be coupled to platform 502 and/or to display 520.

In embodiments, content services device(s) 530 may comprise a cable television box, personal computer, network, telephone, Internet enabled devices or appliance capable of delivering digital information and/or content, and any other similar device capable of unidirectionally or bidirectionally communicating content between content providers and platform 502 and/display 520, via network 560 or directly. It will be appreciated that the content may be communicated unidirectionally and/or bidirectionally to and from any one of the components in system 500 and a content provider via network 560. Examples of content may include any media information including, for example, video, music, medical and gaming information, and so forth.

Content services device(s) 530 receives content such as cable television programming including media information, digital information, and/or other content. Examples of content providers may include any cable or satellite television or radio or Internet content providers. The provided examples are not meant to limit embodiments of the invention.

In embodiments, platform 502 may receive control signals from navigation controller 550 having one or more navigation features. The navigation features of controller 550 may be used to interact with user interface 522, for example. In embodiments, navigation controller 550 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 550 may be echoed on a display (e.g., display 520) by movements of a pointer, cursor, focus ring, or other visual indicators displayed on the display. For example, under the control of software applications 516, the navigation features located on navigation controller 550 may be mapped to virtual navigation features displayed on user interface 522, for example. In embodiments, controller 550 may not be a separate component but integrated into platform 502 and/or display 520. Embodiments, however, are not limited to the elements or in the context shown or described herein.

In embodiments, drivers (not shown) may comprise technology to enable users to instantly turn on and off platform 502 like a television with the touch of a button after initial boot-up, when enabled, for example. Program logic may allow platform 502 to stream content to media adaptors or other content services device(s) 530 or content delivery device(s) 540 when the platform is turned “off.” In addition, chip set 505 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 500 may be integrated. For example, platform 502 and content services device(s) 530 may be integrated, or platform 502 and content delivery device(s) 540 may be integrated, or platform 502, content services device(s) 530, and content delivery device(s) 540 may be integrated, for example. In various embodiments, platform 502 and display 520 may be an integrated unit. Display 520 and content service device(s) 530 may be integrated, or display 520 and content delivery device(s) 540 may be integrated, for example. These examples are not meant to limit the invention.

In various embodiments, system 500 may be implemented as a wireless system, a wired system, or a combination of both. When implemented as a wireless system, system 500 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 500 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 502 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 5.

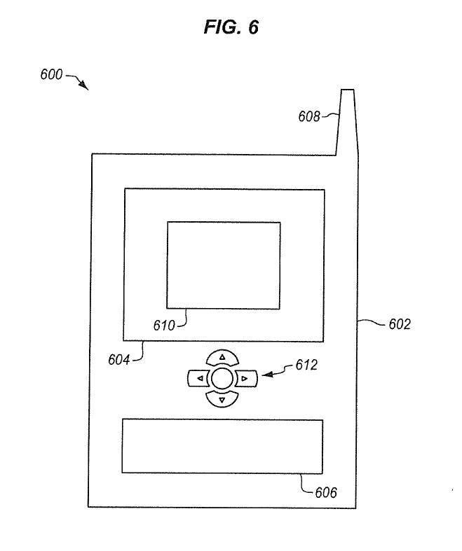

As described above, system 500 may be embodied in varying physical styles or form factors. FIG. 6 illustrates embodiments of a small form factor device 600 in which system 500 may be embodied. In embodiments, for example, device 600 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 6, device 600 may comprise a housing 602, a display 604, an input/output (I/O) device 606, and an antenna 608. Device 600 also may comprise navigation features 612. Display 604 may comprise any suitable display unit for displaying information appropriate for a mobile computing device. I/O device 606 may comprise any suitable I/O device for entering information into a mobile computing device. Examples for I/O device 606 may include an alphanumeric keyboard, a numeric keypad, a touch pad, input keys, buttons, switches, rocker switches, microphones, speakers, voice recognition device and software, and so forth. Information also may be entered into device 600 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. A method comprising:
receiving an instruction;
receiving power values for a central processing core (CPU) and a graphics processing core (GPU);
selecting a core from among the CPU and the GPU based on the received power values; and
sending the instruction to the selected core for processing.

2. The method of claim 1, wherein receiving power values comprises receiving current power consumption values.

3. The method of claim 1, wherein receiving power values comprises receiving power values periodically and storing the received power values for use when receiving an instruction.

4. The method of claim 3, further comprising tracking a history of power values over time using the periodic power values, predicting a future power value for each core based on the tracked history and wherein selecting a core comprises selecting a core based on the predicted future power values.

5. The method of claim 4, wherein tracking a history comprises tracking a history of power consumption compared to maximum possible power consumption for the core.

6. The method of claim 1, further comprising determining a power budget for the CPU and the GPU using the received power values, and wherein selecting a core comprises selecting a core by selecting the core with the largest power budget.

7. The method of claim 6, wherein determining a power budget comprises determining a projected future power consumption compared to a maximum possible power consumption.

8. The method of claim 1, wherein selecting a core comprises selecting the GPU if the GPU has additional power headroom available and selecting the CPU if the GPU does not have additional power headroom.

9. The method of claim 1, wherein receiving an instruction comprises receiving a command and parsing the command into instructions that may be independently processed.

10. The method of claim 9, further comprising sorting the instructions into instructions that must be processed by the CPU, instructions that must be processed by the GPU and instructions that may be processed by either the CPU or the GPU and wherein sending the instruction comprises sending the instructions that may be processed by either the CPU or the GPU to the selected core for processing.

11. A computer-readable medium having instructions stored thereon that, when operated on by the computer, cause the computer to perform operations comprising:
receiving an instruction;
receiving power values for a central processing core (CPU) and a graphics processing core (GPU);
selecting a core from among the CPU and the GPU based on the received power values; and
sending the instruction to the selected core for processing.

12. The medium of claim 11, wherein receiving power values comprises receiving power values periodically and storing the received power values for use when receiving an instruction, the operations further comprising tracking a history of power values over time using the periodic power values, predicting a future power value for each core based on the tracked history and wherein selecting a core comprises selecting a core based on the predicted future power values.

13. The medium of claim 11, wherein receiving an instruction comprises receiving a command and parsing the command into instructions that may be independently processed.

14. An apparatus comprising:
a processing driver to receive an instruction;
a power control unit to send power values for a central processing core (CPU) and a graphics processing core (GPU) to a load balancing engine; and
the load balancing engine to select a core from among the CPU and the GPU based on the received power values and to send the instruction to the selected core for processing.

15. The apparatus of claim 14, wherein the power control unit sends current power consumption values.

16. The apparatus of claim 14, wherein the load balancing engine determines a power budget for the CPU and the GPU using the received power values, and selects a core by selecting the core with the largest power budget.

17. A system comprising:
a central processing core (CPU);
a graphics processing core (GPU);
a memory to store software instructions and data;
a power control unit (PCU) to send power values for the CPU and the GPU to a load balancing engine;
the load balancing engine to store the received power values in the memory, to select a core from among the CPU and the GPU based on the received power values, and to send the instruction to the selected core for processing.

18. The system of claim 17, the load balancing engine selects a core by selecting the GPU if the GPU has additional power headroom available and selecting the CPU if the GPU does not have additional power headroom.

19. The system of claim 17, wherein the load balancing engine further sorts the instructions into instructions that must be processed by the CPU, instructions that must be processed by the GPU and instructions that may be processed by either the CPU or the GPU and sends only instructions that may be processed by either the CPU or the GPU to the selected core for processing.
